(19) United States
(12) Patent Application Publication
(10) Pub. No.: US 2017/0134358 A1
(43) Pub. Date: May 11, 2017

(54) COMMUNICATION SYSTEM, COMMUNICATION CONTROL DEVICE, AND FRAUDULENT INFORMATION-TRANSMISSION PREVENTING METHOD

(71) Applicants: NATIONAL UNIVERSITY CORPORATION NAGOYA UNIVERSITY, Nagoya-shi, Aichi (JP); AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Hiroaki TAKADA, Nagoya-shi (JP); Ryo KURACHI, Nagoya-shi (JP); Naoki ADACHI, Yokkaichi-shi (JP)

(73) Assignees: NATIONAL UNIVERSITY CORPORATION NAGOYA UNIVERSITY, Nagoya-shi, Aichi (JP); AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 15/322,575

(22) PCT Filed: Jun. 26, 2015
(86) PCT No.: PCT/JP2015/068452

§ 371 Date: Dec. 28, 2016

(30) Foreign Application Priority Data
Jul. 14, 2014 (JP) 2014-144038

(51) Int. Cl. H04L 29/06; H04W 12/06; H04W 12/04; H04B 1/3822

(52) U.S. Cl. CPC H04L 63/08; H04B 1/3822; H04W 12/06; H04W 12/04; H04L 2012/40215

(57) ABSTRACT

A plurality of ECUs and a monitoring device are connected to a common CAN bus. Each ECU outputs to the CAN bus a transmission frame where authentication information is added to data to be transmitted to the other ECUs. The monitoring device monitors transmission of a frame to the CAN bus, obtains a frame when the frame is transmitted, and determines right or wrong of authentication information contained in the obtained frame. When the authentication information is not right, there is a possibility that the transmission frame is a fraudulent frame transmitted by malicious equipment, therefore, the monitoring device outputs an error frame to the CAN bus before a final bit of an EOF of the transmission frame is outputted to the CAN bus, and causes the EUCs to discard this transmission frame.

### TECHNICAL FIELD

The present invention relates to a communications system in which a plurality of communication devices such as an ECU (Electronic Control Unit) are connected to each other via a common communication line, a communication control device for preventing fraudulent information-transmission in this system, and a fraudulent information-transmission preventing method.

### BACKGROUND ART

Conventionally, a communication protocol of CAN (Controller Area Network) is widely adopted for the communication among a plurality of communication devices mounted in a vehicle. Since a plurality of communication devices are connected to a common CAN bus in the communication protocol of CAN, an arbitration process is performed by respective communication devices and information with a high priority is transmitted in a case where the plurality of communication devices simultaneously transmit information and a collision occurs. In order to perform the arbitration process, each communication device detects a signal level of the CAN bus at the same time as the output of a transmission signal to the CAN bus. In a case where the detected signal level changes from RECESSIVE (recessive value) to DOMINANT (dominant value) regarding the transmission signal the communication device itself outputs, the communication device determines that a communication collision has occurred and stops the transmission process. DOMINANT is superior to RECESSIVE for signals on the CAN bus and therefore electronic equipment which has outputted DOMINANT can continue the transmission process even when the communication collision occurs.

Patent Document 1 proposes an abnormality diagnosis apparatus which makes a diagnosis of abnormality for each branch circuit of a two-wire CAN communication circuit whose branch connection is made. The abnormality diagnosis apparatus comprises: a branch circuit for inspection which is connector-connected to each branch circuit of a CAN communication line; a branch connection circuit including a joint circuit which connects the branch circuit; separation means which separates each branch circuit from the joint circuit; potential measurement means which measures a potential of the branch circuit separated by the separation means; connection means which connects the potential measurement means to the branch circuit; and abnormality determination means which is connected to the potential measurement means and determines abnormality based on the measured potential.

### PRIOR ART DOCUMENT

### Patent Document

[Patent Document 1] Japanese Patent Laid-Open Publication No. 2010-111295

### SUMMARY OF INVENTION

### Problems to be Solved by Invention

There is a possibility that malicious equipment is connected to a CAN bus of a vehicle. Possibly, the malicious equipment repeatedly transmits fraudulent information to the CAN bus for example to cause malfunction of the other ECU connected to the CAN bus.

The present invention has been made with the aim of solving the above problems, and it is an object of the present invention to provide a communication system, a communication control device and a fraudulent information-transmission preventing method capable of preventing malfunction etc. of a communication device connected to a common communication line, even when fraudulent information is transmitted to the communication line.

### Means for Solving Problems

A communication system according to the present invention is a communication system in which a plurality of communication devices are connected to each other via a common communication line, characterized in that the communication device is provided: with authentication-information adding means for adding authentication information to information to be transmitted to the other communication device; and with information transmitting means for outputting to the communication line transmission information to which the authentication information is added by the authentication-information adding means, and transmitting the transmission information to the other communication device, the communication system comprises a communication control device being connected to the communication line and being provided: with obtaining means for obtaining transmission information outputted to the communication line; with authentication-information determining means for determining whether or not authentication information contained in transmission information obtained by the obtaining means is right; and with information discarding means for causing the communication device to discard the transmission information when the authentication-information determining means determines the authentication information is not right, the information discarding means of the communication control device outputs predetermined information to the communication line when the authentication-information determining means determines the authentication information is not right, and the other communication device discards the transmission information transmitted from the communication device when the other communication device receives the predetermined information from the communication line.

The communication system according to the present invention, the information discarding means of the communication control device outputs the predetermined information to the communication line before the information transmitting means of the communication device completes output of all pieces of transmission information to the communication line, and causes the communication device to discard the transmission information.

The communication system according to the present invention, the communication device and the communication control device share key information, the authentication-information adding means of the communication device generates authentication information based on the key information to add the authentication information to the transmission information, and the authentication-information determining means of the communication control device determines the authentication information contained in the transmission information based on the key information.

The communication system according to the present invention, the plurality of communication devices hold different pieces of key information respectively, and the communication control device holds the key information of each communication device.

A communication control device according to the present invention is a communication control device connected to a common communication line to which a plurality of communication devices are connected, comprising: obtaining means for obtaining transmission information outputted to the communication line; authentication-information determination means for determining whether or not authentication information contained in the transmission information obtained by the obtaining means is right; and information discarding means for causing the communication device to discard the transmission information when the authentication-information determining means determines the authentication information is not right, wherein the information discarding means outputs predetermined information to the communication line when the authentication-information determining means determines the authentication information is not right.

A fraudulent information-transmission preventing method according to the present invention is a fraudulent information-transmission preventing method of preventing fraudulent information-transmission to a common communication line by a communication system in which a plurality of communication devices are connected to each other via the communication line, comprising: the communication device adding authentication information to information to be transmitted to the other communication device and outputting the information to the communication line; a communication control device obtaining transmission information outputted to the communication line; the communication control device determining whether or not authentication information contained in the obtained transmission information is right; the communication control device outputting predetermined information to the communication line when the communication control device determines the authentication information is not right; and the other communication device discarding the transmission information transmitted from the communication device when the other communication device receives the predetermined information from the communication line.

In the present invention, the plurality of communication device and the communication control device are connected to the common communication line. Each communication device adds authentication information to transmission information and outputs the information to the communication line to transmit the information to the other communication device. Note that in the present invention the communication device which receives information from the other communication device does not need to determine right or wrong of authentication information contained in the received information.

The communication control device monitors transmission of information to the communication line, obtains transmitted information when the information is transmitted, and determines right or wrong of authentication information contained in the obtained information. When the authentication information is right, the communication control device does not need to perform any process for this information transmission. When the authentication information is not right, there is a possibility that the transmitted information is fraudulent information transmitted by malicious equipment, and therefore, the communication control device causes the communication device to discard the transmitted information.

This can prevent fraudulent information from being received by each communication device, without determining right or wrong of authentication information by each communication device.

Moreover, in the present invention, in order to cause the communication device to discard transmission information the communication control device outputs predetermined information to the communication line before the communication device completes output of all pieces of transmission information to the communication line. For this reason, the transmission information is not normal information and each communication device stops reception of this information so that the transmission information is discarded.

Moreover, in the present invention the communication device and the communication control device share key information, generate authentication information and determine it. For this reason, malicious equipment not holding key information cannot generate authentication information and then the communication control device can more reliably prevent fraudulent information-transmission.

Moreover, in the present invention the plurality of communication devices in the communication system hold different pieces of key information respectively. This can reduce a negative effect such as leakage of key information. Each communication device does not need to determine authentication information contained in transmission information of the other communication device, therefore it does not need to hold key information of the other communication device. To the contrary, the communication control device holds key information for all communication devices which should discard transmission information. The communication control device determines right or wrong of authentication information contained in the transmission information, using the key information corresponding to the communication device which is a transmission source of information.

### Effects of Invention

According to the present invention, the communication control device determines right or wrong of transmission information based on authentication information to which the communication device adds to the transmission information, and the communication control device causes the communication device to discard this information when the transmission information is not right. Accordingly, even when malicious equipment fraudulently transmits information to the common communication line, the communication control device causes the communication device to discard the transmitted information to prevent malfunction of the communication device.

### BRIEF DESCRIPTION OF DRAWINGS

FIG. 1 is a schematic view showing a configuration of a communication system according to this Embodiment.

FIG. 2 is a block view showing a configuration of the ECU 3.

FIG. 3 is a block view showing a configuration of the monitoring device 5.

FIG. 4 is a schematic view explaining a configuration of the key-information table 52a.

FIG. 5 is a schematic view explaining an outline of a monitoring process of a communication system according to this Embodiment.

FIG. 6 is a schematic view explaining a method of generating a transmission frame by each ECU 3.

FIG. 7 is a flowchart showing a procedure of an information-transmission process to be performed by the ECU 3.

FIG. 8 is a flowchart showing a procedure of a monitoring process to be performed by the monitoring device 5.

FIG. 9 is a flowchart showing a procedure of a monitoring process to be performed by the monitoring device 5.

FIG. 10 is a flowchart showing a procedure of an information-reception process to be performed by the ECU 3.

### MODE FOR CARRYING OUT INVENTION

### <System Configuration>

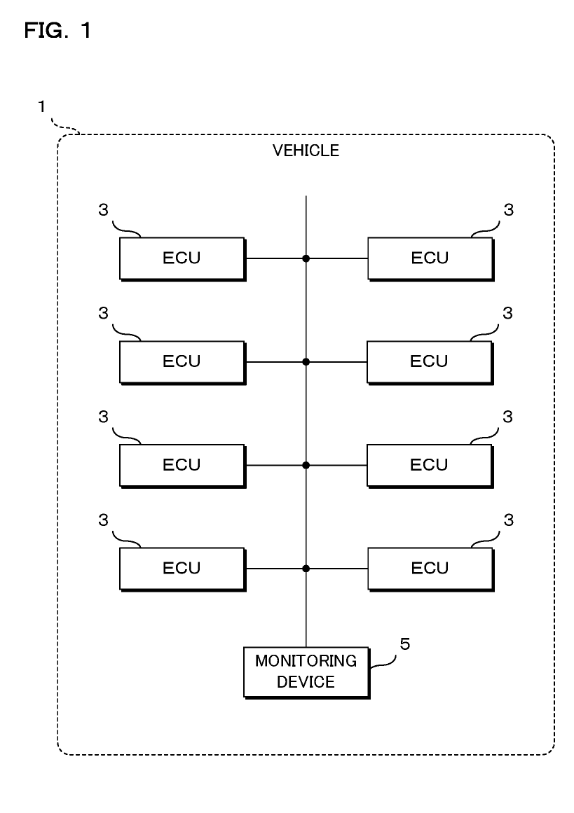

FIG. 1 is a schematic view showing a configuration of a communication system according to this Embodiment. The communications system according to this Embodiment comprises a plurality of ECUs 3 mounted in a vehicle 1 and one monitoring device 5. The ECUs 3 and the monitoring device 5 are connected to each other via a common communication line arranged in the vehicle 1, and can transmit and receive data mutually. In this Embodiment, this communication line is a CAN bus, and the ECUs 3 and the monitoring device 5 communicate according to a CAN protocol. The ECUs 3 may be various electronic control units such as an engine ECU which controls an engine of the vehicle 1, a body ECU which controls electrical components of a vehicle body, an ABS (Antilock Brake System)-ECU which controls an ABS or an air bag ECU which controls an air bag of the vehicle 1, for example. The monitoring device 5 is an apparatus which monitors fraudulent data transmission to an in-vehicle network. The monitoring device 5 may be provided as a device exclusively for monitoring, or may have a configuration where a monitoring function is added to a device such as a gateway or a configuration where the monitoring function is added to any one of the ECUs 3, for example.

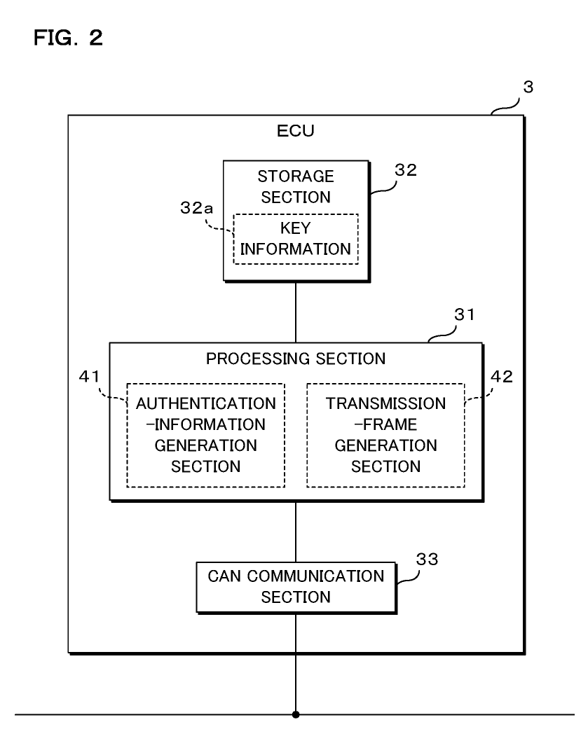

FIG. 2 is a block view showing a configuration of the ECU 3. Note that FIG. 2 shows blocks of communication and fraud monitoring etc. extracted from the ECU 3 provided in the vehicle 1. These blocks are common to each ECU 3. The ECU 3 according to this Embodiment is provided with a processing section 31, a storage section 32 and a CAN communication section 33 and the like. The processing section 31 is constructed from an arithmetic processing unit such as a CPU (Central Processing Unit) or an MPU (Micro-Processing Unit). The processing section 31 read programs stored in the storage section 32 etc. and execute them to perform various information processes or control processes etc. concerning the vehicle 1.

The storage section 32 is constructed from a non-volatile memory device such as a flash memory or an EEPROM (Electrically Erasable Programmable ROM). The storage section 32 stores programs to be executed by the processing section 31 and various data which are necessary for processes to be executed based on the programs. Note that the programs and data stored in the storage section 32 differ for each ECU 3. In this Embodiment, the storage section 32 stores key information 32a used for generation process of authentication information to be performed by the processing section 31. Although the plurality of ECUs 3 are connected to the CAN bus in this Embodiment, the key information 32a which each ECU 3 stores in the storage section 32 may differ from each other.

The CAN communication section 33 communicates with the other ECUs 3 or the monitoring device 5 via the CAN bus according to the communications protocol of CAN. The CAN communication section 33 converts information for transmission provided from the processing section 31 to a transmission signal according to the communication protocol of CAN and outputs the converted signal to the CAN bus to transmit the information to the other ECUs 3 or to the monitoring device 5. The CAN communication section 33 samples a potential of the CAN bus to obtain a signal outputted by the other ECU 3 or the monitoring device 5 and converts this signal to binary information according to the communication protocol of CAN to receive information and then provide the received information to the processing section 31.

In this Embodiment, the processing section 31 of the ECU 3 is provided with an authentication-information generation section 41 and a transmission-frame generation section 42 and the like. The authentication-information generation section 41 and the transmission-frame generation section 42 may be configured as a function block of hardware or as a function block of software. The authentication-information generation section 41 generates authentication information using information to be transmitted to the other ECUs 3 and the key information 32a stored in the storage section 32. The transmission-frame generation section 42 generates a transmission frame (message) suitable for communication in this Embodiment based on information to be transmitted to the other ECUs 3 and authentication information generated by the authentication-information generation section 41. The transmission-frame generation section 42 provides the generated transmission frame to the CAN communication section 33 to transmit information to the other ECUs 3.

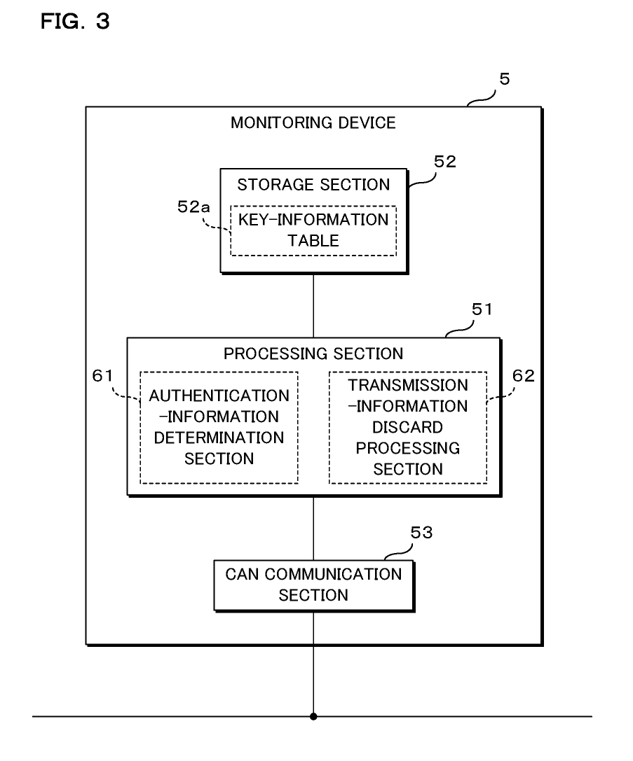

FIG. 3 is a block view showing a configuration of the monitoring device 5. The monitoring device 5 is provided with a processing section 51, a storage section 52 and a CAN communication section 53 and the like. The processing section 51 is constructed from an arithmetic processing unit such as a CPU or an MPU and reads programs stored in the storage section 52 and execute them to monitor behavior and communication and the like of the ECUs 3 of the vehicle 1.

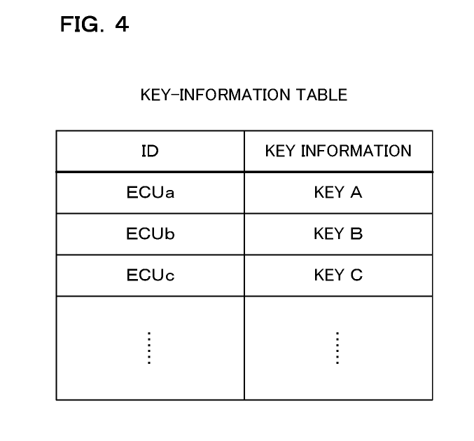

The storage section 52 is constructed from a non-volatile memory device such as a flash memory or an EEPROM which is data-rewritable. In this Embodiment, the storage section 52 stores a key-information table 52a containing key information of all ECUs 3 connected to the CAN bus. FIG. 4 is a schematic view explaining a configuration of the key-information table 52a. In the key-information table 52a that the monitoring device 5 stores in the storage section 52, an ID for identifying each ECU 3 is associated with the key information held in the ECU 3. In this Embodiment, a transmission frame to be transmitted by each ECU 3 contains the ID. Assume that one or a plurality of IDs are allocated to each ECU 3 in advance and the same ID is not allocated to two or more ECUs 3. The monitoring device 5 can obtain one key information from the key-information table 52a, based on the ID contained in the transmission frame of the ECU 3.

The CAN communication section 53 communicates with the ECU 3 via the CAN bus according to the communications protocol of CAN. The CAN communication section 53 converts information for transmission provided from the processing section 51 to a transmission signal according to the communication protocol of CAN and outputs the converted signal to the CAN bus to transmit the information to the ECU 3. The CAN communication section 53 samples a potential of the CAN bus to obtain a signal outputted by the ECU 3 and converts this signal to binary information according to the communication protocol of CAN to receive information and then provide the received information to the processing section 51.

In this Embodiment, the processing section 51 of the monitoring device 5 is provided with an authentication-information determination section 61 and a transmission-information discard processing section 62 and the like. The authentication-information determination section 61 and the transmission-information discard processing section 62 may be configured as a function block of hardware or as a function block of software. The authentication-information determination section 61 determines whether or not authentication information contained in a transmission frame transmitted by the ECU 3 is right. The transmission-information discard processing section 62 causes each ECU 3 to discard this transmission frame when a fraudulent transmission frame is detected.

### <Monitoring Process>

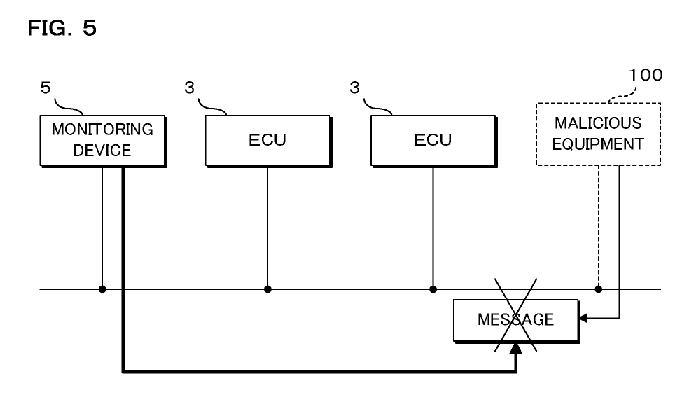

The communication system according to this Embodiment has a function for monitoring fraudulent information-transmission to the CAN bus. FIG. 5 is a schematic view explaining an outline of a monitoring process of a communication system according to this Embodiment. There is a possibility that malicious equipment 100 (shown in FIG. 5 with a dashed line) is fraudulently connected to the CAN bus of the vehicle 1. The malicious equipment 100 transmits to the CAN bus a fraudulent message, for example. The fraudulent message possibly contains control instructions or a sensor detection result etc. for causing malfunction of a normal ECU 3, for example. The monitoring device 5 according to this Embodiment monitors message transmission to the CAN bus. When a message is transmitted to the CAN bus, the monitoring device 5 determines whether or not the message is transmitted from the normal ECU 3. When the message is determined to be fraudulent, the monitoring device 5 outputs a predetermined signal to the CAN bus to cause the ECUs 3 to discard this message before transmission of the message by the malicious equipment 100 is completed (reception of the message by the ECUs 3 is completed).

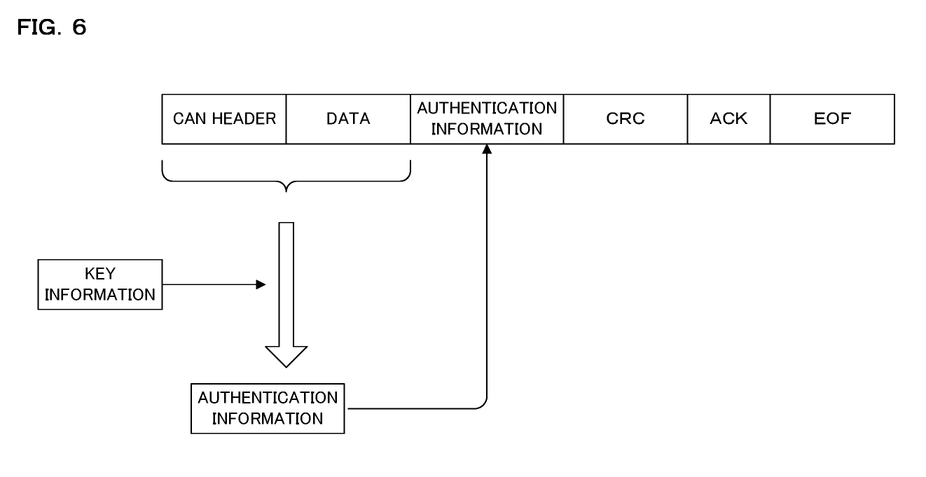

FIG. 6 is a schematic view explaining a method of generating a transmission frame by each ECU 3. A frame (message) to be transmitted and received by the communication system according to this Embodiment contains a CAN header, a data field, authentication information, a CRC (Cyclic Redundancy Check) field, an ACK field and an EOF (END of Frame). The CAN header contains an SOF (Start of Frame), an arbitration field and a control field etc. according to the conventional CAN protocol, as well as the above-described ID for identifying the ECU 3. The data field contains a main portion of information to be transmitted/received among ECUs 3 such as control instructions or a sensor detection result to the ECU 3, for example.

The CRC field, the ACK field and the EOF are the same as those used in the conventional CAN protocol, therefore, the detail thereof is omitted. The CRC field stores information for detecting an error. The ACK field is a field for a reception response by the ECU 3 which receives this frame. The EOF is a specific bit string indicating an end of a field.

The frame according to this Embodiment is compatible with the conventional CAN protocol, but contains authentication information in a part thereof. The authentication information is information used for the monitoring device 5 to determine whether or not the frame is valid. The authentication-information generation section 41 of the ECU 3 encrypts a CAN header and data contained in a transmission frame using the key information 32a stored in the storage section 32 to generate authentication information. In this Embodiment, a message authentication code (MAC) of 256 bits is generated based on the key information 32a of about 512 bits by using an algorithm of an HMAC (SHA-256), for example. The transmission-frame generation section 42 of the ECU 3 adds the MAC of 256 bits generated by the authentication-information generation section 41 to a transmission frame as authentication information and then provides the transmission frame with the CAN communication section 33 to transmit the frame to the other ECUs 3.

Note that in this Embodiment the EUC 3 which receives a frame shown in FIG. 6 does not need to confirm right or wrong of authentication information contained in the received frame. For this reason, each ECU 3 does not share key information with the other ECUs 3.

The CAN communication section 33 of the ECU 3 outputs information of a plurality of bits which constitutes a transmission frame to the CAN bus in sequence from a CAN header side to an EOF side. The monitoring device 5 sequentially obtains information outputted to the CAN bus and when the monitoring device 5 obtains the information up to the CRC field of the transmission frame, the monitoring device 5 detects an error based on the information of the CRC field. When the transmission frame contains no error, the authentication-information determination section 61 of the monitoring device 5 determines right or wrong of authentication information contained in the transmission frame. The authentication-information determination section 61 obtains an ID from the received CAN header, refers to the key-information table 52a of the storage section 52 and obtains key information corresponding to the ID. The authentication-information determination section 61 generates authentication information based on the obtained key information, the received CAN header and data field, according to the same algorithm as the authentication-information generation section 41 of the ECU 3. The authentication-information determination section 61 compares the authentication information generated by itself with the authentication information contained in the transmission frame transmitted to the CAN bus, and determines that this transmission frame is valid when both pieces of authentication information coincide with each other. When both pieces of authentication information do not coincide with each other, the authentication-information determination section 61 determines that this transmission frame is not valid. Note that the authentication-information determination section 61 completes the determination process between output of a final bit of the CRC field of the transmission frame to the CAN bus and output of a final bit of the EOF to the CAN bus.

When the authentication-information determination section 61 determines that the transmission frame outputted to the CAN bus is not valid, the transmission-information discard processing section 62 of the monitoring device 5 causes the ECUs 3 connected to the CAN bus to discard this transmission frame. The transmission-information discard processing section 62 transmits an error frame to the CAN bus during the output period of the EOF of this transmission frame. Based on this error frame, all EUCs 3 connected to the CAN bus discard the fraudulent frame during reception.

### <Flowchart>

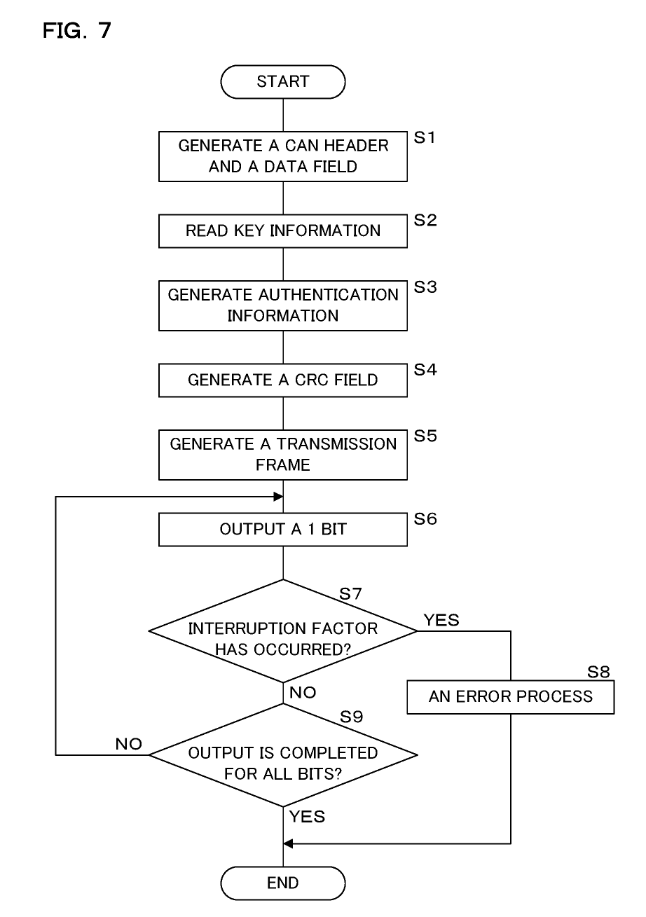

The following explains the process to be performed by the ECU 3 and the monitoring device 5 of the communication system according to this Embodiment, using a flowchart. FIG. 7 is a flowchart showing a procedure of an information-transmission process to be performed by the ECU 3. The processing section 31 of the ECU 3 generates a CAN header and a data field based on information to be transmitted to the other ECUs 3 such as an ID provided to itself and a sensor detection result (step S1). The authentication-information generation section 41 of the processing section 31 reads key information 32a stored in the storage section 32 (step S2). The authentication-information generation section 41 generates authentication information based on the CAN header and the data field generated at step S1 as well as on the key information 32a read at step S2, according to a predetermined algorithm (step S3). The processing section 31 generates a CRC field for detecting an error on the CAN header, the data field and the authentication information (step S4). The processing section 31 combines the CAN header, the data field, the authentication information and the CRC field generated before to generate a transmission frame (step S5), and provide the transmission frame to the CAN communication section 33.

The CAN communication section 33 of the ECU 3 starts transmission from the CAN header of the transmission frame. The CAN communication section 33 obtains 1 bit from a not-transmitted portion of the transmission frame to output a signal corresponding to the 1 bit to the CAN bus (step S6). The CAN communication section 33 determines whether or not an interruption factor in interrupting the transmission process has occurred such as a transmission stop due to the arbitration, for example (step S7). When the interruption factor has occurred (S7: YES), the CAN communication section 33 performs an error process and the like (step S8) to terminate the information-transmission process. When the interruption factor has not occurred (S7: NO), the CAN communication section 33 determines whether or not output is completed for all bits of the provided transmission frame (step S9). When the output is not completed for all bits (S9: NO), the CAN communication section 33 returns the process to step S6 and outputs a next bit of the transmission frame. When the output is completed for all bits (S9: YES), the CAN communication section 33 terminate the information-transmission process.

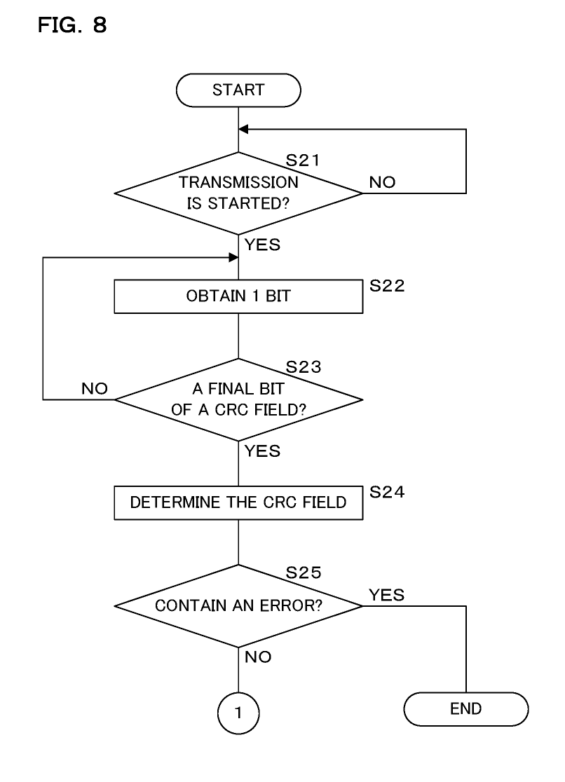

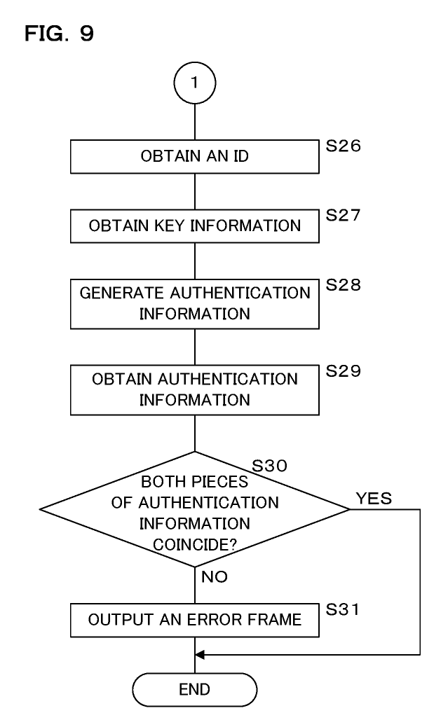

FIGS. 8 and 9 are flowcharts showing a procedure of a monitoring process to be performed by the monitoring device 5. The CAN communication section 53 of the monitoring device 5 periodically samples a potential of the CAN bus. The CAN communication section 53 determines whether or not information-transmission to the CAN bus is started based on a potential change of the CAN bus (step S21). When the information-transmission is not started (S21: NO), the CAN communication section 53 waits until the information-transmission is started. When the information-transmission is started (S21: YES), the CAN communication section 53 obtains 1 bit of the transmission frame based on the potential of the CAN bus (step S22). The CAN communication section 53 determines whether or not the obtained 1 bit corresponds to a final bit of a CRC field (step S23). When the obtained 1 bit does not correspond to the final bit of the CRC field (S23: NO), the CAN communication section 53 returns the process to step S22 and repeatedly obtains each bit of the transmission frame. When the obtained 1 bit corresponds to the final bit of the CRC field (S23: YES), the CAN communication section 53 provides the processing section 51 with the information obtained before.

The processing section 51 determines the CRC field based on the information (transmission frame) provided from the CAN communication section 53 (step S24). The processing section 51 compares a value of a CRC calculated based on the CAN header to the authentication information of the transmission frame with a value of a CRC stored in the CRC field of the transmission frame to determine whether or not the transmission frame contains an error (step S25). When the transmission frame contains an error (S25: YES), the processing section 51 terminates the process. Note that when the transmission frame is determined to contain an error based on the CRC field, the other ECUs 3 are determined in the same way and this transmission frame is discarded by each ECU 3.

When the transmission frame contains no error (S25: NO), the authentication-information determination section 61 of the processing section 51 obtains an ID contained in the CAN header of the transmission frame (step S26). The authentication-information determination section 61 refers to the key-information table 52a of the storage section 52 based on the obtained ID to obtain key information corresponding to the ID (step S27). The authentication-information generation section 61 generates authentication information based on the CAN header and the data field of the obtained transmission frame as well as on the key information obtained at step S27, according to a predetermined algorithm (step S28). The authentication-information determination section 61 obtains authentication information from the transmission frame (step S29) and determines whether or not the obtained authentication information coincides with the authentication information generated at step S28 (step S30). When both pieces of authentication information coincide with each other (S30: YES), the processing section 51 terminates the process. When both pieces of authentication information do not coincide with each other (S30: NO), the transmission-information discard processing section 62 of the processing section 51 outputs an error frame to the CAN bus by the CAN communication section 53 (step S31) and terminates the process.

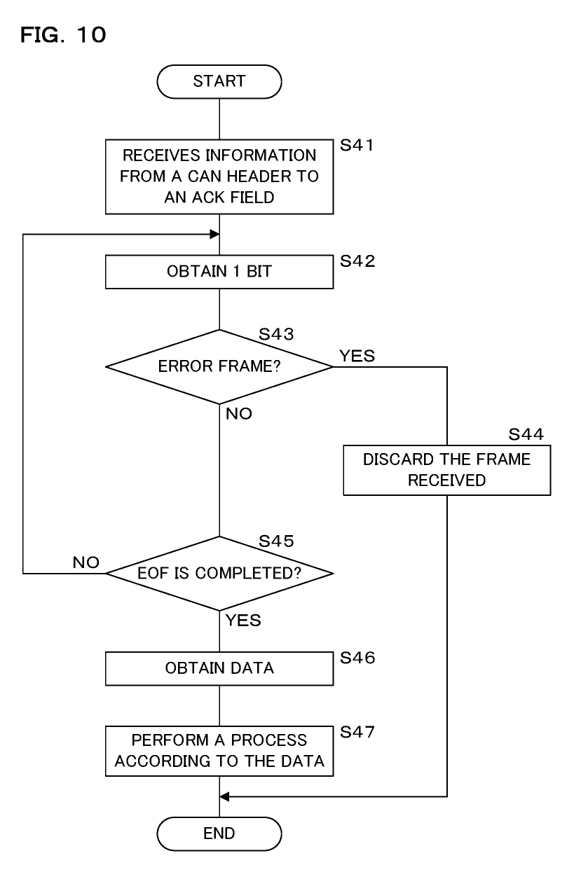

FIG. 10 is a flowchart showing a procedure of an information-reception process to be performed by the ECU 3. The CAN communication section 33 of the ECU 3 first obtains a transmission frame outputted to the CAN bus bit by bit and receives information from a CAN header to an ACK field of the transmission frame (step S41). Note that although the illustration is omitted, the ECU 3 detects presence or absence of an error when the ECU 3 receives the information until a CRC field.

Then, the CAN communication section 33 obtains 1 bit of an EOF of the transmission frame outputted to the CAN bus (step S42). The CAN communication section 33 determines whether or not the obtained 1 bit is not the EOF but an error frame outputted by the monitoring device 5 (step S43). When the obtained 1 bit is the error frame (S43: YES), the CAN communication section 33 discards the frame received before (step S44) and terminates the reception process.

When the obtained 1 bit is not the error frame (S43: NO), the CAN communication section 33 determines whether or not reception of the EOF is completed (step S45). When the reception of the EOF is not completed (S45: NO), the CAN communication section 33 returns the process to step S42 and continues the reception of the EOF. When the reception of the EOF is completed (S45: YES), the processing section 31 obtains necessary data from a data field of the frame received by the CAN communication section 33 (step S46), performs a process according to the obtained data (step S47) and terminates the process.

### <Conclusion>

The communication system according to this Embodiment having the above configuration connects the plurality of ECUs 3 and the monitoring device 5 to the common CAN bus. Each ECU 3 outputs to the CAN bus by the CAN communication section 33 a transmission frame in which authentication information is added to data to be transmitted to the other ECUs 3, to transmit information to the other ECUs 3. Note that in this Embodiment the EUC 3 which receives a frame from the other ECU 3 does not need to determine right or wrong of authentication information contained in the received frame. The monitoring device 5 monitors the transmission of a frame to the CAN bus, obtains the frame when the frame is transmitted, and determines right or wrong of authentication information contained in the obtained frame. When the authentication information is right, the monitoring device 5 does not need to perform any process for this frame. When the authentication information is not right, there is a possibility that the transmission frame is a fraudulent frame transmitted by the malicious equipment 100, therefore, the monitoring device 5 causes the EUCs 3 to discard this transmission frame. This can prevent a fraudulent frame from being received by each ECU 3, without determining right or wrong of authentication information by each ECU 3.

In this Embodiment, in order to cause each ECU 3 to discard a transmission frame, the monitoring device 5 outputs an error frame to the CAN bus before a final bit of an EOF of the transmission frame is outputted to the CAN bus. For this reason, each ECU 3 stops reception of this transmission frame and discards the transmission frame.

In this Embodiment, the monitoring device 5 and the ECUs 3 share key information, generate authentication information and determine it. For this reason, malicious equipment 100 not holding key information cannot generate authentication information and then the monitoring device 5 can more reliably prevent transmission of a fraudulent frame.

In this Embodiment, the plurality of ECUs 3 connected to the CAN bus hold different pieces of key information, respectively. This can reduce a negative effect such as leakage of key information. Each EUC 3 does not need to determine right or wrong of authentication information contained in a transmission frame of the other ECU 3, therefore each ECU 3 does not need to hold key information of the other ECUs 3. To the contrary, the monitoring device 5 holds key information for all EUCs 3 and manages key information in the storage section 52 as the key-information table 52a. The monitoring device 5 can determine the ECU 3 which is a transmission source based on an ID contained in a transmission frame and read corresponding key information from the key-information table 52a to determine right or wrong of authentication information contained in the transmission frame.

Note that although in this Embodiment the ECUs 3 and the monitoring device 5 communicate with each other according to the CAN protocol, it is not limited to such a configuration and the ECUs 3 and the monitoring device 5 may communicate with each other according to a protocol other than the CAN protocol. Moreover, although in this Embodiment the communication system mounted in the vehicle 1 is explained as an example, the communication system is not limited to be mounted in the vehicle 1 and may be mounted in a movable body such as an airplane or a ship. For example, the communication system may be arranged in a factory, an office or a school etc. instead of the movable body. Moreover, the configuration of a frame illustrated in this Embodiment is one example and is not limited to this. Moreover, the monitoring device 5 is not arranged in the communication system but any one of the ECUs 3 may have a monitoring function of the monitoring device 5 according to this Embodiment. A method of sharing key information among the ECUs 3 and the monitoring device 5 may be adopted in any method. Moreover, a cryptographic process performed by the ECUs 3 and the monitoring device 5 using key information may be performed according to any algorithm. Moreover, although the processing section 51 performs the generation process of authentication information and the discard process of a transmission frame and the like, it is not limited to this and the CAN communication section 53 may perform a part or all of the processes.

### DESCRIPTION OF REFERENCE NUMERALS

1 vehicle
3 ECU
5 monitoring device
31 processing section
32 storage section
32a key information
33 CAN communication section
41 authentication-information generation section
42 transmission-frame generation section
51 processing section
52 storage section
52a key-information table
53 CAN communication section
61 authentication-information determination section
62 transmission-information discard processing section
100 malicious equipment

1-6. (canceled)

7. A communication system comprising
a communication line connecting a plurality of communication devices,
wherein the communication device is provided:
with authentication-information adding part adding authentication information to information to be transmitted to the other communication device; and
with information transmitting part outputting to the communication line transmission information to which the authentication information is added by the authentication-information adding part, and transmitting the transmission information to the other communication device,
the communication system further comprises a communication control device being connected to the communication line and being provided: with obtaining part obtaining transmission information outputted to the communication line; with authentication-information determining part determining whether or not authentication information contained in transmission information obtained by the obtaining part is right; and with information discarding part causing the communication device to discard the transmission information when the authentication-information determining part determines the authentication information is not right,
the information discarding part of the communication control device outputs predetermined information to the communication line when the authentication-information determining part determines the authentication information is not right, and
the other communication device discards the transmission information transmitted from the communication device when the other communication device receives the predetermined information from the communication line.

8. The communication system according to claim 7, wherein the information discarding part of the communication control device outputs the predetermined information to the communication line before the information transmitting part of the communication device completes output of all pieces of transmission information to the communication line, and causes the communication device to discard the transmission information.

9. The communication system according to claim 7, wherein the communication device and the communication control device share key information,
the authentication-information adding part of the communication device generates authentication information based on the key information to add the authentication information to the transmission information, and
the authentication-information determining part of the communication control device determines the authentication information contained in the transmission information based on the key information.

10. The communication system according to claim 9, wherein the plurality of communication devices hold different pieces of key information respectively, and
the communication control device holds the key information of each communication device.

11. A communication control device connected to a common communication line to which a plurality of communication devices are connected, comprising:
obtaining part obtaining transmission information outputted to the communication line;
authentication-information determination part determining whether or not authentication information contained in the transmission information obtained by the obtaining part is right; and
information discarding part causing the communication device to discard the transmission information when the authentication-information determining part determines the authentication information is not right,
wherein the information discarding part outputs predetermined information to the communication line when the authentication-information determining part determines the authentication information is not right.

12. A fraudulent information-transmission preventing method of preventing fraudulent information-transmission to a common communication line by a communication system in which a plurality of communication devices are connected to each other via the communication line, comprising:
the communication device adding authentication information to information to be transmitted to the other communication device and outputting the information to the communication line;
a communication control device obtaining transmission information outputted to the communication line;
the communication control device determining whether or not authentication information contained in the obtained transmission information is right;
the communication control device outputting predetermined information to the communication line when the communication control device determines the authentication information is not right; and
the other communication device discarding the transmission information transmitted from the communication device when the other communication device receives the predetermined information from the communication line.
